(19) United States
(12) Patent Application Publication
(10) Pub. No.: US 2021/0397676 A1
(43) Pub. Date: Dec. 23, 2021

(54) OUTSOURCED DATA PROCESSING

(71) Applicant: Nokia Technologies Oy, Espoo (FI)

(72) Inventors: Anmin FU, Xi'an (CN); Jingyu FENG, Shaanxi (CN)

(21) Appl. No.: 17/292,189

(22) PCT Filed: Nov. 16, 2018
(86) PCT No.: PCT/CN2018/116052

§ 371 Date: May 7, 2021

(51) Int. Cl. G06F 17/16

(52) U.S. Cl. CPC G06F 17/16

(57) ABSTRACT

An apparatus comprising at least one processing core (310), at least one memory (320) including computer program code, the at least one memory (320) and the computer program code being configured to, with the at least one processing core (310), cause the apparatus at least to generate a set of three permutation matrices {P, Q and R}(510), apply the set of permutation matrices on a data matrix V and matrices W¹ and H¹, wherein matrices W¹ and H¹ comprise only non-negative elements, such that: elements aa, bb and cc, and provide matrices dd, ee and ff to a server for processing (530).

### FIELD

The present invention relates to outsourcing data processing functions, for example from a client device to a cloud processing server.

### BACKGROUND

In the era of big data, the increasing popularity of portable electronics ranging from smart phones to tablet devices fuels increased data volumes in mobile networks. Further, machine-type devices produce large quantities of raw data, which may need processing and/or storage. Data may have redundant properties and it may, further, be of low quality. Such data may benefit from being integrated into a more compact representation.

Providing data to an outside party, such as a cloud processing party, for processing, involves risks as the data is handed over to another entity, which may be less trusted than an in-house processing substrate, such as a processor grid, for example.

### SUMMARY OF THE INVENTION

According to some aspects, there is provided the subject-matter of the independent claims. Some embodiments are defined in the dependent claims.

According to a first aspect of the present invention, there is provided an apparatus comprising at least one processing core, at least one memory including computer program code, the at least one memory and the computer program code being configured to, with the at least one processing core, cause the apparatus at least to generate a set of three permutation matrices {P, Q and R}, apply the set of permutation matrices on a data matrix V and matrices W¹ and H¹, wherein matrices W¹ and H¹ comprise only non-negative elements, such that: \tilde{V}←PVQ⁻¹, \tilde{W}¹←PW¹R⁻¹ and \tilde{H}¹←RH¹Q⁻¹, and provide matrices \tilde{V}, \tilde{W}¹, and \tilde{H}¹ to a server for processing.

According to a second aspect of the present invention, there is provided a method comprising generating, in an apparatus, a set of three permutation matrices {P, Q and R}, applying the set of permutation matrices on a data matrix V and matrices W¹ and H¹, wherein matrices W¹ and H¹ comprise only non-negative elements, such that \tilde{V}←PVQ⁻¹, \tilde{W}¹←PW¹R⁻¹ and \tilde{H}¹←RH¹Q⁻¹, and provide matrices \tilde{V}, \tilde{W}¹, and \tilde{H}¹ to a server for processing.

According to a third aspect of the present invention, there is provided an apparatus comprising at least one processing core, at least one memory including computer program code, the at least one memory and the computer program code being configured to, with the at least one processing core, cause the apparatus at least to receive, from a client device, matrices \tilde{V}, \tilde{W}¹, and \tilde{H}¹, perform an alternating non-negative least squares projected gradient method based non-negative matrix factorization procedure to factorize matrix \tilde{V} into matrices \tilde{W}* and \tilde{H}*, wherein dimensions of matrices \tilde{W}* and \tilde{H}* are lower than those of matrix \tilde{V}, and provide matrices \tilde{W}* and \tilde{H}* to the client device.

According to a fourth aspect of the present invention, there is provided a method, comprising receiving, from a client device, matrices \tilde{V}, \tilde{W}¹, and \tilde{H}¹, performing an alternating non-negative least squares projected gradient method based non-negative matrix factorization procedure to factorize matrix \tilde{V} into matrices \tilde{W}* and \tilde{H}*, wherein dimensions of matrices \tilde{W}* and \tilde{H}* are lower than those of matrix \tilde{V}, and providing matrices \tilde{W}* and \tilde{H}* to the client device.

According to a fifth aspect of the present invention, there is provided an apparatus comprising means for generating, in an apparatus, a set of three permutation matrices {P, Q and R}, means for applying the set of permutation matrices on a data matrix V and matrices W¹ and H¹, wherein matrices W¹ and H¹ comprise only non-negative elements, such that \tilde{V}←PVQ⁻¹, \tilde{W}¹←PW¹R⁻¹ and \tilde{H}¹←RH¹Q⁻¹, and means for providing matrices \tilde{V}, \tilde{W}¹, and \tilde{H}¹ to a server for processing.

According to a sixth aspect of the present invention, there is provided an apparatus comprising means for receiving, from a client device, matrices \tilde{V}, \tilde{W}¹, and \tilde{H}¹, means for performing an alternating non-negative least squares projected gradient method based non-negative matrix factorization procedure to factorize matrix \tilde{V} into matrices \tilde{W}* and \tilde{H}*, wherein dimensions of matrices \tilde{W}* and \tilde{H}* are lower than those of matrix \tilde{V}, and means for providing matrices \tilde{W}* and \tilde{H}* to the client device.

According to a seventh aspect of the present invention, there is provided a non-transitory computer readable medium having stored thereon a set of computer readable instructions that, when executed by at least one processor, cause an apparatus to at least generate, in an apparatus, a set of three permutation matrices {P, Q and R}, apply the set of permutation matrices on a data matrix V and matrices W¹ and H¹, wherein matrices W¹ and H¹ comprise only non-negative elements, such that \tilde{V}←PVQ⁻¹, \tilde{W}¹←PW¹R⁻¹ and \tilde{H}¹←RH¹Q⁻¹, and provide matrices \tilde{V}, \tilde{W}¹, and \tilde{H}¹ to a server for processing.

According to an eighth aspect of the present invention, there is provided a non-transitory computer readable medium having stored thereon a set of computer readable instructions that, when executed by at least one processor, cause an apparatus to at least receive, from a client device, matrices \tilde{V}, \tilde{W}¹, and \tilde{H}¹, perform an alternating non-negative least squares projected gradient method based non-negative matrix factorization procedure to factorize matrix \tilde{V} into matrices \tilde{W}* and \tilde{H}*, wherein dimensions of matrices \tilde{W}* and \tilde{H}* are lower than those of matrix \tilde{V}, and provide matrices \tilde{W}* and \tilde{H}* to the client device.

According to a ninth aspect of the present invention, there is provided a computer program configured to cause, when run on a computer, at least the following: generating, in an apparatus, a set of three permutation matrices {P, Q and R}, applying the set of permutation matrices on a data matrix V and matrices W¹ and H¹, wherein matrices W¹ and H¹ comprise only non-negative elements, such that \tilde{V}←PVQ⁻¹, \tilde{W}¹←PW¹R⁻¹ and \tilde{H}¹←RH¹Q⁻¹, and providing matrices \tilde{V}, \tilde{W}¹, and \tilde{H}¹ to a server for processing.

According to a tenth aspect of the present invention, there is provided a computer program configured to cause, when run on a computer, at least the following: receiving, from a client device, matrices \tilde{V}, \tilde{W}¹, and \tilde{H}¹, performing an alternating non-negative least squares projected gradient method based non-negative matrix factorization procedure to factorize matrix \tilde{V} into matrices \tilde{W}* and \tilde{H}*, wherein dimensions of matrices \tilde{W}* and \tilde{H}* are lower than those of matrix \tilde{V}, and providing matrices \tilde{W}* and \tilde{H}* to the client device.

### BRIEF DESCRIPTION OF THE DRAWINGS

FIG. 1 illustrates an example system in accordance with at least some embodiments of the present invention;

FIG. 2 illustrates a system model in accordance with at least some embodiments of the present invention;

FIG. 3 illustrates an example apparatus capable of supporting at least some embodiments of the present invention;

FIG. 4 illustrates signalling in accordance with at least some embodiments of the present invention;

FIG. 5 is a flow graph of a method in accordance with at least some embodiments of the present invention, and

FIG. 6 is a flow graph of a method in accordance with at least some embodiments of the present invention.

### EMBODIMENTS

In accordance with technology described herein, offloading computation to achieve matrix factorisation to lower-dimensional matrices can be obtained while protecting the processed data against disclosure to the party performing the offloaded computation. Furthermore, dynamically updated data may be thus handled, and the client directing the offloading may check that the party performing the offloaded computation has performed the requested computations as requested, providing the effect of increased dependability of the offloading process.

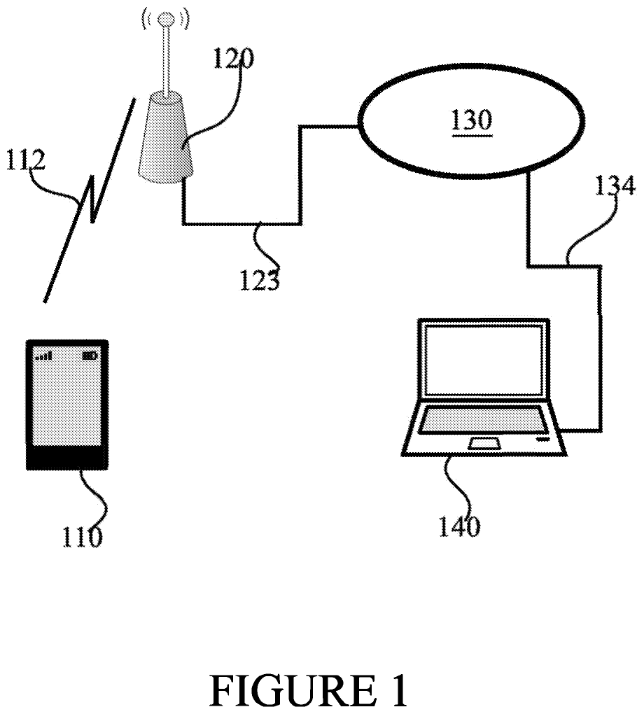

FIG. 1 illustrates an example system in accordance with at least some embodiments of the present invention. Client device, CL, 110 is in this example a smartphone, but more generally the client device may be any suitable apparatus, such as a tablet computer, a laptop computer, a desktop computer, Internet of Things node, a medical sensor device, or a computing grid, for example.

In the illustrated example, client device 110 is in wireless communication with access node 120 via wireless link 112, which may comprise an uplink for conveying information from client device 110 to access node 120, and a downlink for conveying information from access node 120 to client device 110. Wireless link 112 may operate in accordance with a cellular or non-cellular technology, such as wireless local area network, WLAN, worldwide interoperability for microwave access, WiMAX, long term evolution, LTE, or new radio, NR, also known as 5G.

Access node 120 is in communication with network 130 via connection 123. Network 130 may comprise the Internet, or, for example, a corporate network. Cloud service provider, CSP, 140 is interfaced with network 130 via connection 134. Through network 130 and access node 120, CL 110 and CSP 140 may exchange information, such as computation processing orders and results thereof. Communication between end nodes CL 110 and CSP 140 may be secured, for example using cryptographic protocols such as transport layer security, TLS, or secure shell, SSH. Access node 120 and network 130 may pass such cryptographic protocols transparently without participating in them as endpoints.

CSP 140 may comprise a commercial cloud computing provider or supercomputer, or in general a counterparty, which is willing to perform computation tasks on behalf of CL 110.

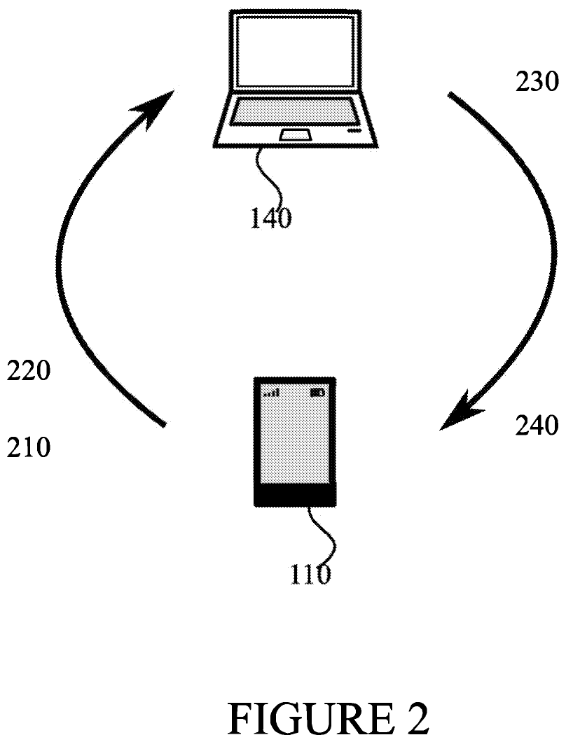

FIG. 2 illustrates a system model in accordance with at least some embodiments of the present invention. CL 110 and CSP 140 correspond to like entities as described above in connection with FIG. 1. In the system model, an overall process is divided into four stages. A first stage, 210, comprises generation of permutation matrices in CL 110. A second stage, 220, comprises applying the set of permutation matrices on a data matrix V and matrices W¹ and H¹, the permuted matrices \tilde{V}, \tilde{W}¹ and \tilde{H}¹ then being provided to CSP 140 for non-negative matrix factorization, NMF. CSP 140 completes the NMF factorization of \tilde{V} into \tilde{W}* and \tilde{H}* as will be described herein, in stage 230. Stage 240, which is optional, comprises CL 110 checking the processing in CSP 140 was honest.

Non-negative matrix factorization, NMF, is a data integration algorithm that lowers matrix data dimensions, while retaining the basis information from which the original data may be reconstructed. This may be expressed as V=WH. Here V is the dataset, while W represents parts-based features and H is a codification matrix. In a sense, we can consider each original document in the original high-dimensional dataset as being built from a small set of hidden features. NMF generates these features. NMF has been introduced in [1], which is herein referred to as disclosing NMF such that the skilled person may use NMF. NMF is used, for example, in the fields of optimization, neural computing, pattern recognition, astronomy and machine learning. Computing tasks such as data statistics and data mining, are complex, also involving computing costs and energy consumption. Thereupon, users may be unwilling to handle them locally using their client devices, which may be resource constrained. Cloud computing provides a solution to this dilemma, called outsourced computing. Outsourcing computing means outsourcing the data to a third party to complete calculation and get the results back. Owing to its powerful computing and storage capacities, cloud computing can meet the needs of outsourced computing. Specifically, the data owner can outsource the data to the cloud for computing.

CSP 140 may be a dishonest, or at least untrusted, from the point of view of CL 110. It may snoop on user data or compute unreliably, which causes problems for the data owner. For example, medical data can disclose a person's physical condition, and photographs may reveal private information, such as age, height and social connections. CSP 140 may retain the data furtively for commercial use. Even worse, the CSP 140 may neglect computational integrity and return erroneous results, for example to save costs or energy. Therefore, a secure and dependable outsourcing scheme is needed when relying on outsourced computing.

Though NMF has broad application, it is challenging to perform for resource-constrained users with large datasets. In detail, NMF is a non-polynomial-hard, NP-hard, problem, which is not easy to perform for local users [2]. Thus, it may be desirable to outsource NMF processing to the cloud. Existing studies have addressed security challenges faced by outsourcing NMF, including data confidentiality and cheating resilience. However, these proposed schemes have had little practical implication. There are two reasons for this drawback. One is that their schemes are based on Lee and Seung's traditional iteration algorithm [3] which converges slowly. The other is that they overlook the study of dynamically updated data.

Duan et al. [4] proposed an outsourced scheme for large-scale NMF, which can lighten the client's overhead. To protect input and output data privacy, they introduced permutation matrices to disrupt the original matrix and results. This permutation mechanism is lightweight and easy to implement for the client. To handle verification of results, Duan et al. put forward a single-round verification strategy. According to the iterative nature of NMF computation, this verification strategy succeeds in guaranteeing that the client can verify the correctness of results with small overhead.

Similar to the Duan's study, Liu et al. [5] also applied a permutation technique to maintain privacy, the permutation transforming the original problem into a permutated one. It prevents the cloud from stealing the client's data by obfuscating it. To achieve resilience against cheating at the CSP, Liu et al. utilized a matrix 1-norm technique to verify the result. This check technique can both detect error results, and also reduce the verification cost, benefiting the client device.

In accordance with embodiments described herein, a secure outsourcing scheme is presented to address issues in existing schemes. More specifically, an Alternating Non-negative Least Squares using projected gradient method, ANLS, [6] is employed, which has a faster convergence than traditional NMF algorithms. An iterative method based on ANLS is herein employed to solve the NMF problem. Furthermore, using dynamically updated data is enabled. Document [6] is herein referred to as disclosing ANLS such that the skilled person may use ANLS.

A new dynamic data outsourcing NMF scheme is presented, which not only can be applied to analysis image data, text data, audio data and other non-negative database, but also can handle with dynamic data as well. We consider a scenario where CL 110 outsources a large-scale non-negative dataset V to a CSP 140 for processing. CSP 140 is not unconditionally trusted. There are two main threats coming from CSP 140, namely data privacy leakage and unreliable results, as described above.

To address the data privacy issue, a matrix permutation technique is employed to mask the original data. This technique disrupts data location in the matrix by permutation. Generally, the matrix permutation is based on two mathematical functions: Kronecker delta function and permutation.

The Kronecker delta function is defined for input numbers x, y as:

$${δ}_{x , y} = \{ \begin{matrix}1 , & if x = y \\ 0 , & otherwise\end{matrix}$$

Permutation is herein used as follows: Denote φ:S→S, where S={s₁, s₂, . . . , sₙ}. φ is actually a bijective function, namely φ(sᵢ)=sⱼ. Its inverse permutation is φ⁻¹(sⱼ)=sᵢ. In particular, a permutation matrix may be generated using the following Algorithm 1:

1. Taken a parameter λ, generate a species space [symbol] on a non-
empty finite field [symbol] _{q}, and a random permutation φ of the
integers {1, . . . , n};
2. Select a set of non-null random number α from [symbol] where α =
{α₁, α₂, . . . , αₙ};
3. Get a permutation matrix like M(i, j) = αᵢδ_{φ(i), j}, and its
inverse is M⁻¹(i, j) = δ_{φ}_{^{−1}}^{_{(j), i}}/αⱼ.

For example three permutation matrices may be generated using the algorithm described above, or a variant thereof.

To detect unreliable results, an algorithm is used combining with a stop condition in the iterative ANLS method. Generally, \tilde{W}^{k}=\tilde{W}^{k-1} and \tilde{H}^{k}=\tilde{H}^{k-1} imply that the solution to NMF has been found. However, due to the way the iterative NMF method works, an unreliable CSP may respond to the CL 110 with a result of the previous (k−1)-th iteration for the k-th iteration without computing the k-th iteration completely. This misbehavior cannot be detected by only checking whether \tilde{W}^{k}=\tilde{W}^{k-1} and \tilde{H}^{k}=\tilde{H}^{k-1} are true. Besides, ∥\tilde{V}−\tilde{W}*\tilde{H}*∥<∈ is often used to detect forged results, but this condition does not reveal whether a solution is close to a stationary point or not. It fails to detect results that are not fully calculated. This defect can be resolved using the stop condition in ANLS method, which is

∥∇f̅(\tilde{W}*,\tilde{H}*)∥_{F}≥∈∥∇f̅(\tilde{W}¹,\tilde{H}¹)∥_{F}.

To handle updates to data after sending matrices to CSP 140 for processing, the following procedure may be employed. Considering a multivariate dataset composed of n samples, each of which contains a large number of features, the original dataset may be seen as a high-dimension matrix V. Meanwhile, the data to be processed may be dynamic, which means CL 110 may have some new data after outsourcing the data V for processing to CSP 140. Suppose CL 110 obtains new dataset V′ after outsourcing the data V to CSP 140 for NMF processing, and he also wants to integrate V′ by NMF. Obviously, one solution would be to conduct the entire scheme again to complete the task, but it would be cumbersome and uneconomical. Considering that matrix W holds main features extracted from the training data V and matrix H is the codification of the parts-based characteristics, we can keep matrix W constant and update only matrix H, and not W, for new data V′. Thus CL 110 may provide to CSP 140 only the permutated matrices \tilde{V}′ and \tilde{H}′ and not W.

An overall example algorithm is described in detail in the following. Firstly, the permutation matrix generation is described:

Taken a security parameter λ, CL first utilizes Algorithm 1 to generate three permutation matrices P, Q and R. One thing to note here is that [symbol] for Q is {1}. Then CL keeps them as secret encryption/decryption keys [symbol] ={P, Q, R}.

In connection with updating data, permutation matrix generation involves the following: CSP 140 keeps matrix \tilde{W}* and CL 110 keeps secret encryption/decryption keys [symbol] ={P, Q, R}, and CL 110 generates a new permutation matrix T by Algorithm 1 and initializes H_{bj}′≥0.

Next, use of the permutation matrices is described:

Choosing an appropriate r, CL 110 initializes W_{id}¹≥0, H_{bj}¹≥0, ∀i, a, b, j. Then CL 110 takes matrices V, W¹, H¹ and [symbol] to obtain permuted matrices:

$$\tilde{V} ← {PVQ}^{- 1}$$

$${\tilde{W}}^{1} ← P {W}^{1} {R}^{- 1} , and$$

$${\tilde{H}}^{1} ← R {H}^{1} {Q}^{- 1} .$$

CL 110 sends \tilde{V}, \tilde{W}¹ and \tilde{H}¹ to CSP 140.

In connection with updating data, use of the permutation matrices comprises CL 110 computing \tilde{V}′←PV′T⁻¹ and \tilde{H}′←RH′T⁻¹. CL then sends \tilde{V}′ and \tilde{H}′ to CSP 140.

Next, NMF factorization is described:

CSP 140 run the ANLS algorithm to decompose the matrix \tilde{V}, and obtain the optimal solution \tilde{W}* and \tilde{H}*. In connection with updating data, NMF factorization comprises CSP 140 using matrices \tilde{V}′, \tilde{W}* to update \tilde{H}′, then returning the final result \tilde{H}′* to CL 110.

Next, result verification is described:

After receiving \tilde{W}*, \tilde{H}* returned by CSP 140, CL 110 conducts verification by checking whether ∥∇f̅(\tilde{W}*,\tilde{H}*)∥_{F}≥∈∥∇f̅(\tilde{W}¹,\tilde{H}¹)∥_{F} is true. Once \tilde{W}*, \tilde{H}* pass verification, CL 110 can obtain W* and H* by following computation: W*←P⁻¹\tilde{W}*R and H*←R⁻\tilde{H}*Q.

In connection with updating data, result verification comprises CL 110 conducting the result verification check to check the correctness of \tilde{H}′*, and obtaining the un-permuted matrix H′* according to H′*←R⁻¹ [symbol] *T.

Technical effects provided by the described embodiments include achieving data confidentiality and detection of unreliable processing in a CSP, dynamic data updating and ease of implementation which does not require use of actual cryptographic algorithms to secure data.

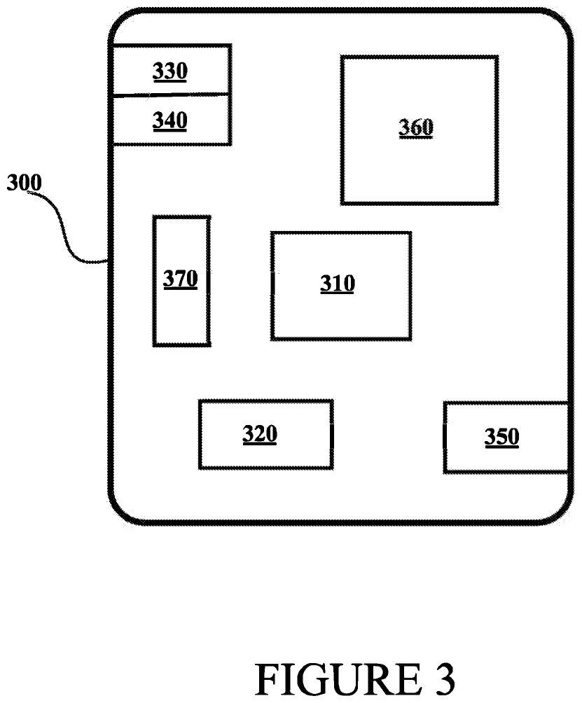

FIG. 3 illustrates an example apparatus capable of supporting at least some embodiments of the present invention. Illustrated is device 300, which may comprise, for example, a mobile communication device such as CL 110 or, in applicable parts, CSP 140 of FIG. 1. Comprised in device 300 is processor 310, which may comprise, for example, a single- or multi-core processor wherein a single-core processor comprises one processing core and a multi-core processor comprises more than one processing core. Processor 310 may comprise, in general, a control device. Processor 310 may comprise more than one processor. Processor 310 may be a control device. A processing core may comprise, for example, a Cortex-A8 processing core manufactured by ARM Holdings or a Steamroller processing core designed by Advanced Micro Devices Corporation. Processor 310 may comprise at least one Qualcomm Snapdragon and/or Intel Atom processor. Processor 310 may comprise at least one application-specific integrated circuit, ASIC. Processor 310 may comprise at least one field-programmable gate array, FPGA. Processor 310 may be means for performing method steps in device 300. Processor 310 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300.

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to accept incoming telephone calls, to originate telephone calls or video calls, to browse the Internet, to manage digital files stored in memory 320 or on a cloud accessible via transmitter 330 and receiver 340, or via NFC transceiver 350, and/or to play games.

Device 300 may comprise or be arranged to accept a user identity module 370. User identity module 370 may comprise, for example, a subscriber identity module, SIM, card installable in device 300. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a NFC transceiver 350 and/or user identity module 370.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

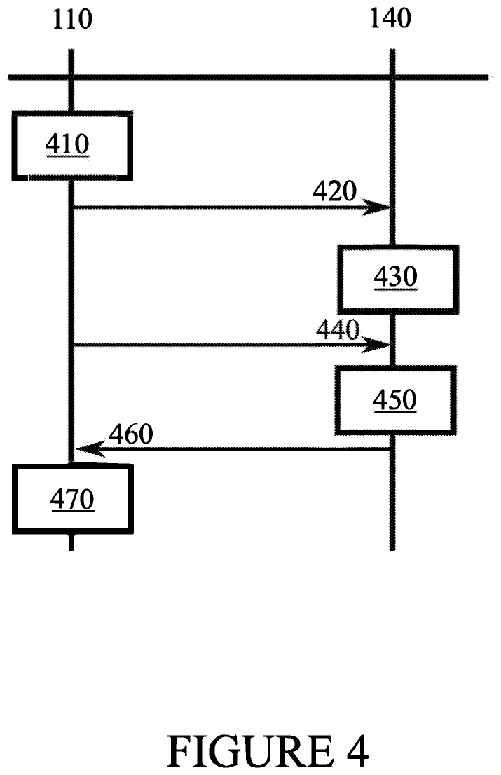

FIG. 4 illustrates signalling in accordance with at least some embodiments of the present invention. On the vertical axes are disposed, on the left, CL 110 of FIG. 1, and on the right, a CSP 140. Time advances from the top toward the bottom.

In phase 410, CL 110 obtains data, for example by performing a sensor-based measurement of a physical property, such as acceleration, or a biological measurement, such as blood sugar and/or pulse. Likewise on phase 410, CL 110 generates permutation matrices and used them to permute an initial matrix V, which contains the data.

In phase 420, CL 110 provides the permuted matrices to CSP 140, which begins working on them in phase 430, to complete NMF processing, for example by using the ANLS algorithm. In phase 440, CL 110 provides updated data to CSP 140, in terms of re-providing matrices \tilde{V}′ and \tilde{H}′. CSP 140 processes the updated data in phase 450.

In phase 460, CSP 140 provides the permuted result matrices \tilde{W}* and \tilde{H}* to CL 110, which may check the result is correct, as described above, and de-permute the matrices to obtain the actual result matrices W* and H*.

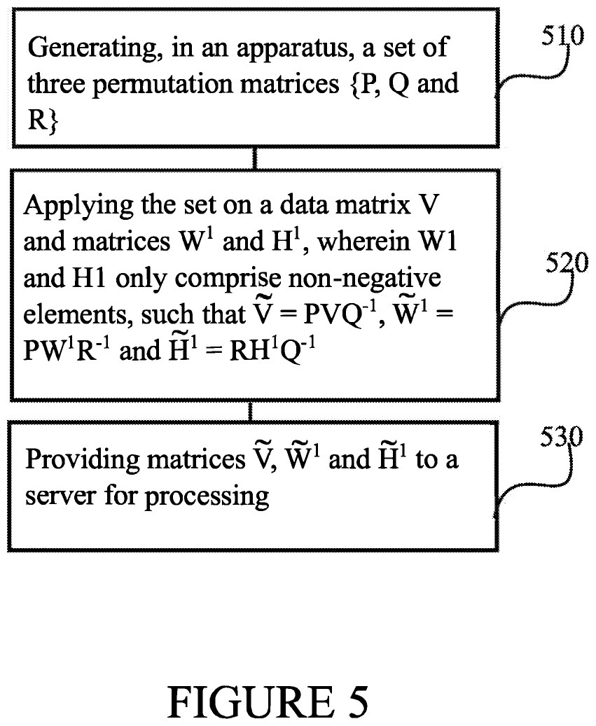

FIG. 5 is a flow graph of a method in accordance with at least some embodiments of the present invention. The phases of the illustrated method may be performed in CL 110, an auxiliary device or a personal computer, for example, or in a control device configured to control the functioning thereof, when installed therein.

Phase 510 comprises generating, in an apparatus, a set of three permutation matrices {P, Q and R}. Phase 520 comprises applying the set of permutation matrices on a data matrix V and matrices W¹ and H¹, wherein matrices W¹ and H¹ comprise only non-negative elements, such that \tilde{V}←PVQ⁻¹, \tilde{W}¹←PW¹R⁻¹ and \tilde{H}¹←RH¹Q⁻¹. Finally, phase 530 comprises providing matrices \tilde{V}, \tilde{W}¹, and \tilde{H}¹ to a server for processing.

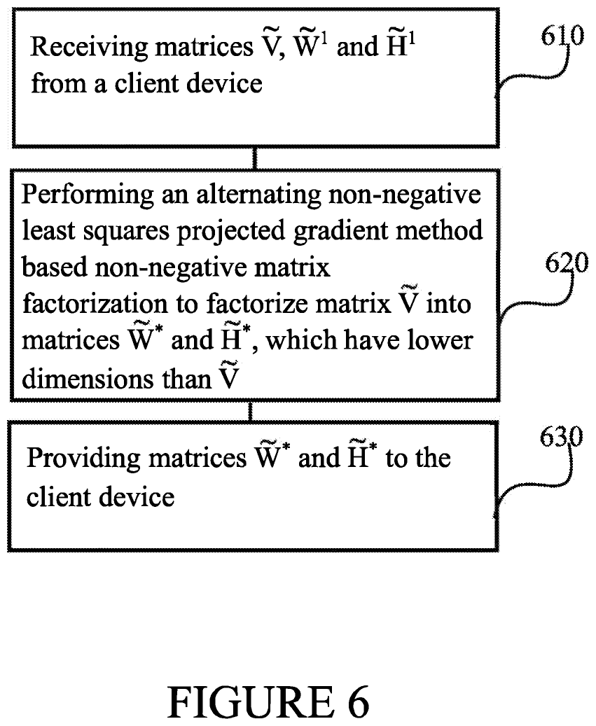

FIG. 6 is a flow graph of a method in accordance with at least some embodiments of the present invention. The phases of the illustrated method may be performed in CSP 140, an auxiliary device or a personal computer, for example, or in a control device configured to control the functioning thereof, when installed therein.

Phase 610 comprises receiving, from a client device, matrices \tilde{V}, \tilde{W}¹, and \tilde{H}¹. Phase 620 comprises performing an alternating non-negative least squares projected gradient method based non-negative matrix factorization procedure to factorize matrix \tilde{V} into matrices \tilde{W}* and \tilde{H}*, wherein dimensions of matrices \tilde{W}* and \tilde{H}* are lower than those of matrix \tilde{V}. Finally, phase 630 comprises providing matrices \tilde{W}* and \tilde{H}* to the client device.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in in offloading computational processing.

REFERENCE SIGNS LIST

| | |
|---|---|
| 110 | Client device |
| 112 | Wireless link |
| 120 | Access node |
| 130 | Network |
| 140 | Cloud service provider |
| 123, 134 | Connections |
| 210 | Permutation matrix generation |
| 220 | Applying the set of permutation matrices |
| 230 | NMF factorization |
| 240 | Result checking |
| 300-370 | Structure of the device of FIG. 3 |
| 410-470 | Phases of the method of FIG. 4 |
| 510-530 | Phases of the method of FIG. 5 |
| 610-630 | Phases of the method of FIG. 6 |

### CITATION LIST

[1] D. Lee and H. Seung, “Learning the Parts of Objects by Non-Negative Matrix Factorization,” Nature, vol. 401, no. 6755, pp. 788-791, 1999.
[2] S. A. Vavasis, “On the complexity of nonnegative matrix factorization,” SIAM Journal on Optimization, vol. 20, no. 3, pp. 1364-1377, 2007.
[3] D. D. Lee and H. S. Seung, “Algorithms for non-negative matrix factorization.” Advances in Neural Information Processing Systems, vol. 13, no. 6, pp. 556-562, 2000
[4] J. Duan, J. Zhou, Y. Li. “Secure and Verifiable Outsourcing of Nonnegative Matrix Factorization (NMF).” in ACM IH & MMSEC, pp. 63-68, 2016.
[5] Z. Liu, B. Li, and Q. Han, “Secure and verifiable outsourcing protocol for non-negative matrix factorization,” International Journal of High Performance Computing and Networking, vol. 11, no. 1, pp. 14, 2018.
[6] C. J. Lin, “Projected gradient methods for nonnegative matrix factorization,” Neural Computation, vol. 19, no. 10, pp. 2756-2779, 2007.

1-25. (canceled)

26. An apparatus comprising at least one processing core, at least one memory including computer program code, the at least one memory and the computer program code being configured to, with the at least one processing core, cause the apparatus at least to:
generate a set of three permutation matrices {P, Q and R};
apply the set of permutation matrices on a data matrix V and matrices W¹ and H¹, wherein matrices W¹ and H¹ comprise only non-negative elements, such that:
$$\tilde{V} ← {PVQ}^{- 1}$$
$${\tilde{W}}^{1} ← P {W}^{1} {R}^{- 1} , and$$
$${\tilde{H}}^{1} ← R {H}^{1} {Q}^{- 1} ;$$
and
provide matrices \tilde{V}, \tilde{W}¹, and \tilde{H}¹ to a server for processing.

27. The apparatus according to claim 26, wherein the apparatus is configured to generate the set of permutation matrices such that each permutation matrix element (i, j) of each permutation matrix is αᵢδ_{φ(i),j}, where φ:S→S, where S={s₁, s₂, . . . , sₙ}, φ being a bijective permutation, α={α₁, α₂, . . . , αₙ} is a set of non-null numbers generated randomly by the apparatus, and δ is the Kronecker delta function.

28. The apparatus according to claim 26, wherein the apparatus is further configured to receive, from the server, processed matrices \tilde{W}* and \tilde{H}*.

29. The apparatus according to claim 28, wherein the apparatus is further configured to obtain matrices W* and H* by performing the following:
$${W}^{*} ← {P}^{- 1} \tilde{W} * R and$$
$${H}^{*} ← {R}^{- 1} {\tilde{H}}^{*} Q .$$

30. The apparatus according to claim 28, wherein the apparatus is further configured to verify that the processing in the server has been performed correctly.

31. The apparatus according to claim 30, wherein the verification that the processing in the server has been performed correctly comprises checking whether
∥∇f̅(\tilde{W}*,\tilde{H}*)∥_{F}≥∈∥∇f̅(\tilde{W}¹,\tilde{H}¹)∥_{F}
is true.

32. The apparatus according to claim 26, wherein the apparatus is further configured to update the data provided to the server by providing an updated matrices V and \tilde{H}¹ only, wherein W comprises main features of extracted from data vector V.

33. The apparatus according to claim 26, wherein the apparatus comprises a mobile user device.

34. A method comprising:
generating, in an apparatus, a set of three permutation matrices {P, Q and R};
applying the set of permutation matrices on a data matrix V and matrices W¹ and H¹, wherein matrices W¹ and H¹ comprise only non-negative elements, such that:
$$\tilde{V} ← {PVQ}^{- 1}$$
$${\tilde{W}}^{1} ← P {W}^{1} {R}^{- 1} and$$
$${\tilde{H}}^{1} ← R {H}^{1} {Q}^{- 1} ;$$
and
providing matrices \tilde{V}, \tilde{W}¹, and \tilde{H}¹ to a server for processing.

35. The method according to claim 34, further comprising generating the set of permutation matrices such that each permutation matrix element (i, j) of each permutation matrix is αᵢδ_{φ(i),j}, where φ:S→S, where S={s₁, s₂, . . . , sₙ}, φ being a bijective permutation, α={α₁, α₂, . . . , αₙ} is a set of non-null numbers generated randomly by the apparatus, and δ is the Kronecker delta function.

36. The method according to claim 34, further comprising receiving, from the server, processed matrices \tilde{W}* and \tilde{H}*.

37. The method according to claim 36, further comprising obtaining matrices W* and H* by performing the following:
$${W}^{*} ← {P}^{- 1} \tilde{W} * R and$$
$${H}^{*} ← {R}^{- 1} {\tilde{H}}^{*} Q .$$

38. The method according to claim 36, further comprising verifying that the processing in the server has been performed correctly.

39. The method according to claim 38, wherein the verification that the processing in the server has been performed correctly comprises checking whether
∥∇f̅(\tilde{W}*,\tilde{H}*)∥_{F}≥∈∥∇f̅(\tilde{W}¹,\tilde{H}¹)∥_{F}
is true.

40. The method according to claim 34, further comprising updating the data provided to the server by providing an updated matrices V and \tilde{H}¹ only, wherein W comprises main features of extracted from data vector V.

41. An apparatus comprising at least one processing core, at least one memory including computer program code, the at least one memory and the computer program code being configured to, with the at least one processing core, cause the apparatus at least to:
receive, from a client device, matrices \tilde{V}, \tilde{W}¹, and \tilde{H}¹;
perform an alternating non-negative least squares projected gradient method based non-negative matrix factorization procedure to factorize matrix \tilde{V} into matrices \tilde{W}* and \tilde{H}*, wherein dimensions of matrices \tilde{W}* and \tilde{H}* are lower than those of matrix \tilde{V}; and
provide matrices \tilde{W}* and \tilde{H}* to the client device.

42. The apparatus according to claim 41, wherein the apparatus is configured to receive, during the factorization procedure, from the client device, an updated matrix \tilde{H}¹ only, and to update the factorization procedure such that the updated matrix \tilde{H}¹ is used in determining matrices \tilde{W}* and \tilde{H}*.
